(19) United States
(12) Patent Application Publication
(10) Pub. No.: US 2004/0240930 A1
(43) Pub. Date: Dec. 2, 2004

(54) Binding device for holding sheet materials or sleeves for compact discs

(76) Inventor: Braden Lindley Smith, Boulder, CO (US)

Correspondence Address: SHERIDAN ROSS PC, 1560 BROADWAY, SUITE 1200, DENVER, CO, 80202

(21) Appl. No.: 10/754,890

(22) Filed: Jan. 8, 2004

Related U.S. Application Data
(60) Provisional application No. 60/438,917, filed on Jan. 8, 2003.

(51) Int. Cl. B42F 3/00

(52) U.S. Cl. 402/70

(57) ABSTRACT

A binding mechanism is provided for securing compact disc sleeves and other sheet material in a notebook binder or wallet and which preferably can be quickly and selectively opened and closed by utilizing a resilient strap locking mechanism.

This application claims priority of U.S. provisional patent application S/N 60/438,917, filed Jan. 8, 2003, which is incorporated herein in its entirety by reference. In addition, this application is related to U.S. Pat. No. 6,665,868, issued Dec. 2, 2003, which is incorporated herein in its entirety by reference.

### FIELD OF THE INVENTION

The present invention relates to mechanisms for securing sheet materials in a binding device such as a notebook, binder, or wallet, and more specifically sheet materials such as sleeves that are adapted to secure compact discs and other similar media.

### BACKGROUND OF THE INVENTION

Binding devices are commonly used for securing flat sheet materials such as paper sheets, in a protective covering. Most commonly, 3-ring binders are often used that typically provide three rigid, circular metallic rings that selectively snap open for insertion or removal of sheet materials. The circular metallic rings are locked in a closed position to prevent the sheet materials from inadvertently becoming unsecured from the binding device. One drawback of traditional binding devices is that they are often rigid, and not suitable for use in more flexible notebooks. Further, the metallic ring halves are prone to deformation, which may result in a gap therebetween that may allow the sheet materials to become unsecured or tear after repeated use.

In addition, typical 3-ring binding devices include metallic materials that are expensive to manufacture. These types of binding devices may additionally rust and generally require a very rigid backing plate mechanism to provide sufficient support.

Thus, there is a long felt need for a cost effective binding mechanism that may be employed in flexible notebook or wallet storage devices, and which allows flexible sheet materials such as compact disc sleeves to be selectively interconnected to the flexible binding device without being obstructed or damaged during use. Additionally, there is a significant need for a binding device that is flexible, and thus suitable for use in compact disk wallets and other similar non-rigid devices. The following disclosure describes an improved binding mechanism that is adapted for interconnection to a notebook or wallet type device, which is adapted to selectively secure a plurality of compact discs or similar media therein.

### SUMMARY OF THE INVENTION

It is thus one aspect of the present invention to provide a flexible binding device that may be employed for selective insertion and removal of sheet materials in a notebook or wallet type storage device. Alternatively, the binding device may be designed in a manner that would not allow the removal of the sheet materials once they are inserted and secured within the binding device. Preferably, the binding mechanism is operated without tools, and is simplistic in design to quickly allow the insertion and removal of sheet materials, yet provides a secure, fail-proof system that prevents the sheet materials from inadvertently becoming unsecured. The sheet materials may be paper writing sheets, but more typically are sleeves such as flexible polyethylene sheets capable of holding a plurality of compact discs (CDs), Digital Video Discs (DVDs), CD ROMs or other similar type media (hereinafter “CDs”) in one or more pockets. Typically the graphics associated with the CDs are also stored in a pocket positioned in proximity to the sleeve.

It is a further aspect of the present invention to provide a flexible binding device that is constructed from non-metallic components, is cost effective to manufacture, and is made primarily of resilient material which may be used in a flexible yet durable wallet or notebook.

Thus, in one embodiment of the present invention, a binding device is provided which is adapted for holding sheet materials in a notebook, comprising:

a spine comprising a left edge, a right edge, an inner surface, and an outer surface with at least one aperture extending therethrough;

at least one strap interconnected to at least one of said left edge and said right edge of said spine and having a first end and a second end, said second end having at least one recess positioned proximate thereto which has reduced width with respect to said second end of said at least one strap;

a latching mechanism comprising a left edge, a right edge, an inner surface, and an outer surface, with at least one aperture extending therethrough, said spine adapted for interconnection to the notebook with said latching mechanism positioned below said spine, wherein said left edge of said spine and said left edge of said latching mechanism are substantially parallel, and said outer surface of said spine and said inner surface of said latching mechanism are slidingly engaged; and

wherein said latching mechanism has a first unlocked position and a second locked position relative to said spine, wherein said aperture of said spine and said aperture of said latching mechanism are substantially overlapped in said first unlocked position to receive said second end of said at least one strap, and wherein said aperture of said spine and said aperture of said latching mechanism are offset in said second locked position wherein said second end of said at least one strap is substantially secured to said spine.

It is yet another aspect of the present invention to provide a method for selectively securing sheet materials in a notebook binding device, comprising the steps of:

providing a substantially planar spine having at least one aperture therethrough, said spine also having an inner surface, an outer surface, and two lateral edges with at least one strap adapted to secure the sheet materials interconnected to a lateral edge, said strap having an end with cutouts proximate thereto;

providing a latching mechanism comprising a left edge, a right edge, an inner surface, and an outer surface, and with at least one aperture therethrough; wherein said spine is adapted to be interconnected to said notebook with said latching mechanism therebetween said outer surface of said spine and said inner surface of said latching mechanism being slidingly engaged;

wherein said latching mechanism has a first position and a second position relative to said spine, wherein said aperture of said spine and said aperture of said latching mechanism are substantially overlapped in said first position, and wherein said aperture of said spine and said aperture of said latching mechanism are substantially offset in said second position.

moving said latching mechanism to said first position;

operably interconnecting at least one of said sheet materials to said at least one strap;

resiliently deflecting said at least one strap such that said end is threaded through said aperture of said spine and said aperture of said latching mechanism, thereby positioning said cutouts proximate to said apertures; and

moving said latching mechanism to said second position, wherein the edge of said aperture of said latching mechanism is selectively engaged onto one of said cutouts, and wherein said apertures are overlapped thus preventing the removal of said strap.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated herein and constitute a part of the specification, illustrate embodiments of the invention and together with the general description of the invention given above and the detailed description of the drawings given below, serve to explain the principles of these embodiments.

FIG. 1 is a perspective view of a binder that employs a binding device of the present invention;

FIG. 2 is a front elevation view showing one embodiment of the present invention interconnected to the binder of FIG. 1, wherein the binding device is configured for insertion and/or removal of storage sheets;

FIG. 3 is a front elevation view of the embodiment of the present invention shown in FIG. 2;

FIG. 4 is a front elevation view of the embodiment of the present invention shown in FIG. 2, wherein the binding device is shown selectively interconnected to a spine, thus securing the storage sheet;

FIG. 5 is a partial top plan view of the embodiment shown in FIG. 2, wherein the locking strip is in the unlocked position;

FIG. 6 is a partial top plan view of the embodiment shown in FIG. 2, wherein the locking strip is in the locked position.

FIG. 7 is a partial front elevation view of a strap end employed in the embodiment of the present invention shown in FIG. 2;

FIG. 8 is a top perspective view of an alternate strap latching mechanism;

FIG. 9 is a partial front elevation view of an alternate strap end employed with the latching mechanism shown in FIG. 8;

FIG. 10 is a partial front cross-section view of the latching mechanism shown in FIG. 9 just prior to insertion of the strap; and

FIG. 11 is a partial cross-section view of the latching mechanism shown in FIG. 9 with the strap locked into the latching mechanism.

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

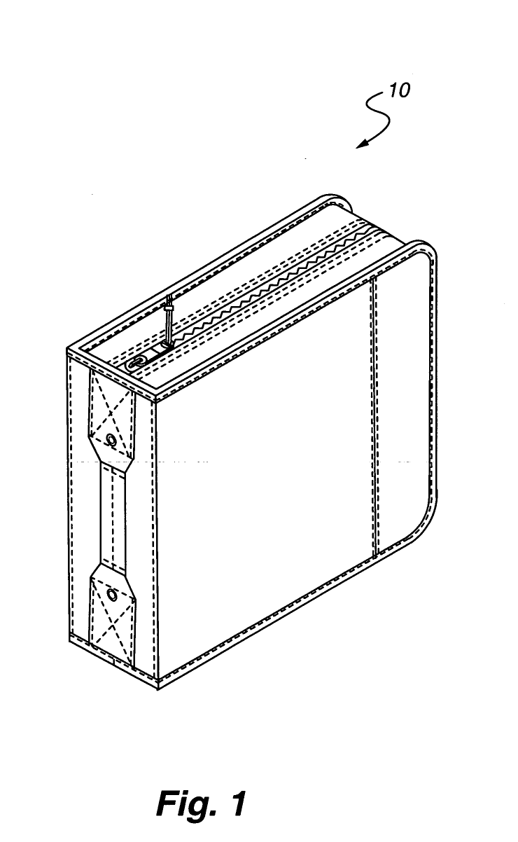

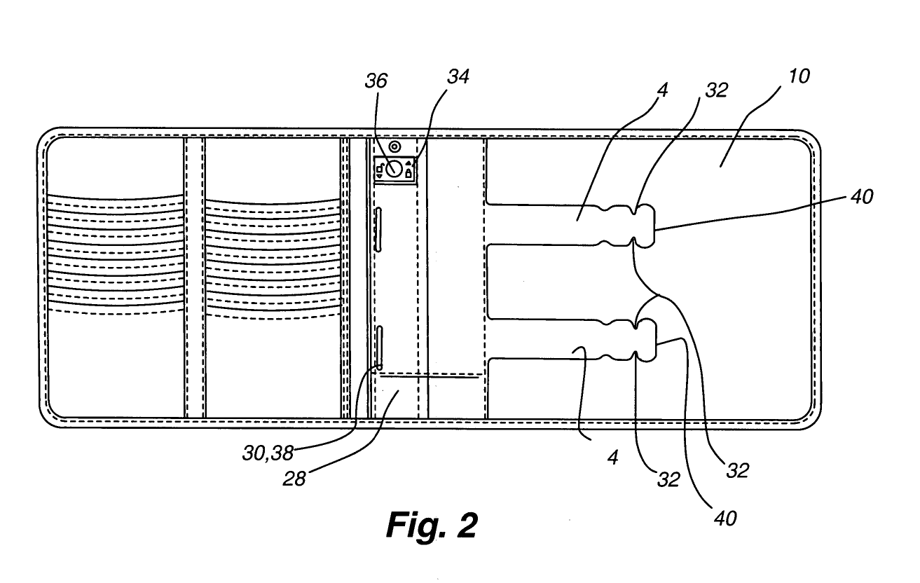

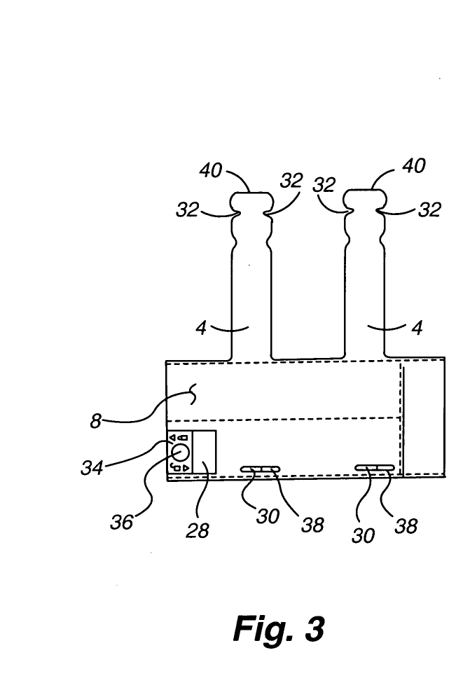

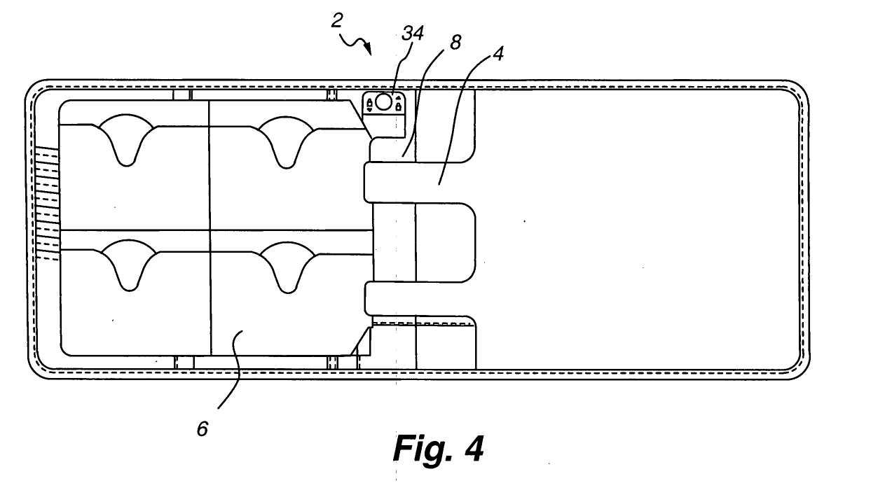

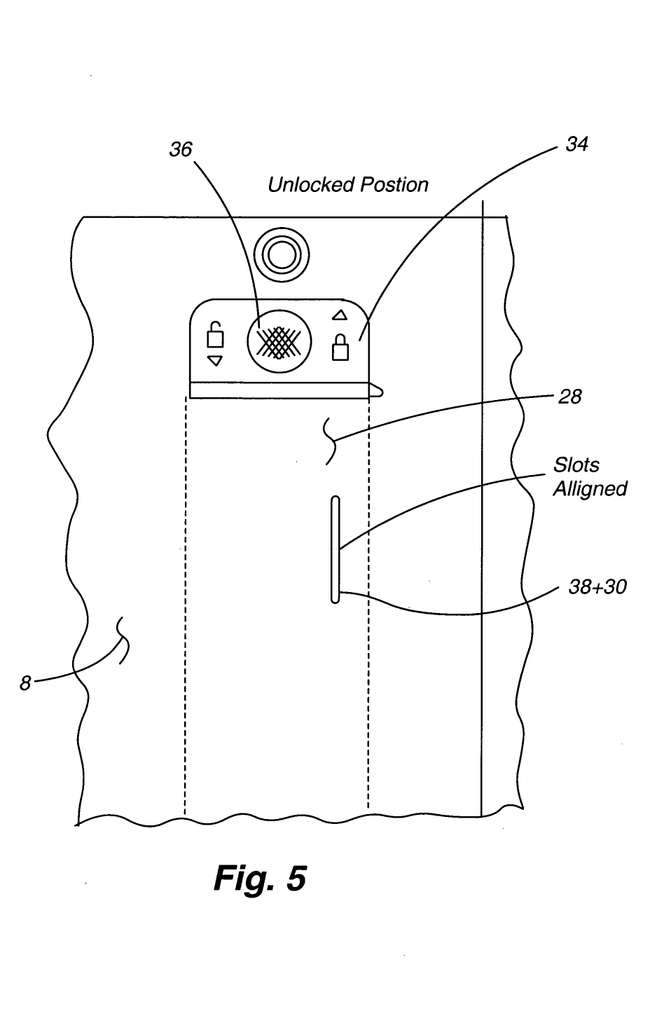

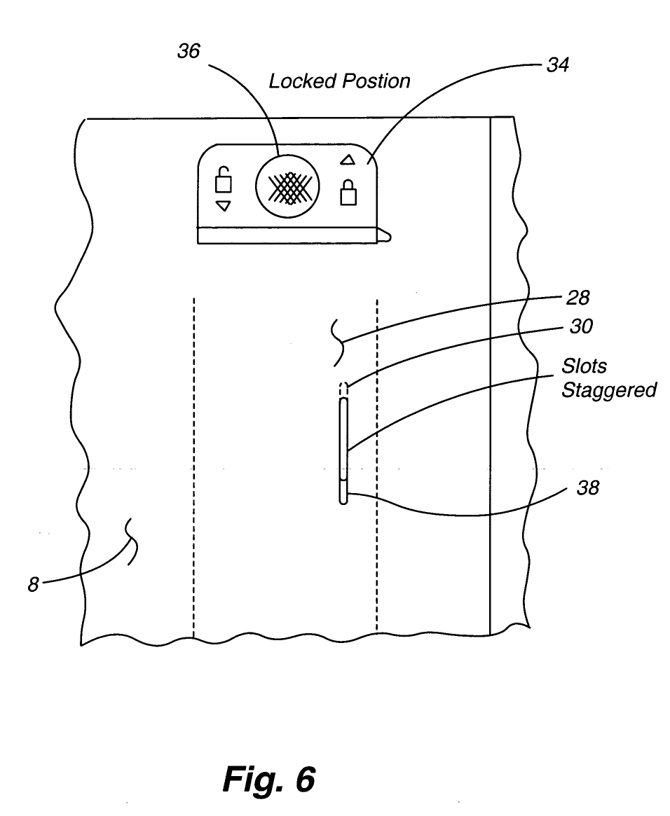

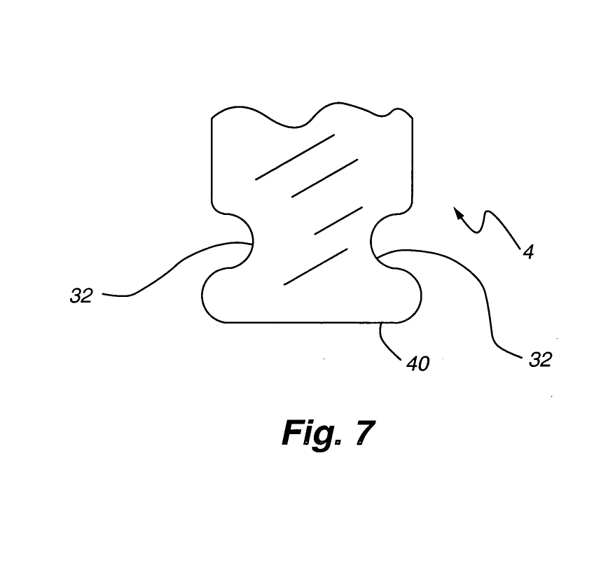

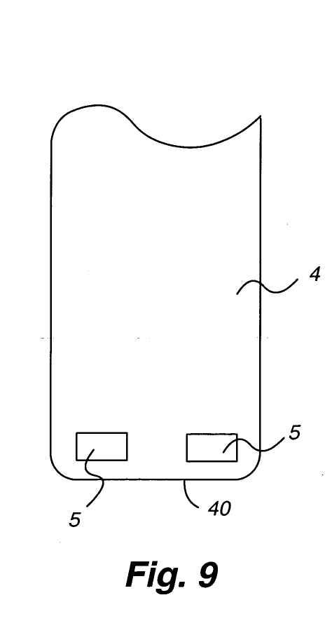

Referring now to FIGS. 1-11, a sheet binding device 2 is shown herein. In one embodiment of the present invention, a binding device 2 is provided that includes at least one strap 4 that is adapted to secure a plurality of sheets 6 that hold CDs. The resiliently deflectable strap 4, which is interconnected to a spine 8 is threaded through an aperture in the sheet 6 and selectively interconnected to a latching mechanism 12 on the spine 8 that allows for easy insertion and removal of the strap 4. Alternatively, the strap 4 may selectively interconnect to the spine 8 on both ends with two latching mechanisms, thereby providing the user greater insertion and removal options.

Referring now to FIGS. 1-7, one embodiment of the present invention is shown herein. More specifically, the binding device 2 employs at least one strap 4 that is adapted to hold a plurality of sheets 6. Preferably, the sheets 6 are adapted to hold CDs, but other types of media may be secured by the present invention. Preferably, it is desirable to make the straps 4 sufficiently wide to prevent point loads that tend to tear the sheets 6. The flexible resilient straps 4, in one embodiment of the present invention are operably interconnected to the spine 8 that interconnects to a binder 10. In addition, a locking strip 28 is employed that includes at least one slot 30 that is capable of selective interconnection with a cutout 32 on the strap 4. More specifically, the locking strip 28 is selectively interconnected to the spine 8, wherein sliding the locking strip 28 initiates locking and unlocking of the strap 4 from the binder. Preferably, the strap 4 is capable of selective interconnection on both ends. Alternatively, one end may be fixed to the binder 10 as described above. Preferably, the locking strip 28 further includes a tab 34 with lock/unlock indicators and a binder interconnection mechanism 36. In one embodiment of the present invention the interconnection mechanism 36 is a snap as used frequently on clothing articles, but any type of mechanism that prevents motion of the locking strip may be employed, such as hook & loop materials, i.e., velcro, buttons, latches, zippers, mechanical fasteners, or other selective interconnection means known in the art.

In order to secure the sheets 6 in the binder 10, the user initially verifies that a tab 34 is in an unlocked position, thereby aligning locking strip slots 30 and slots 38 integrated into the spine 8. Once the strap 4 is threaded through the desired amount of sheets 6, its end 40 is slid through the slots 30 & 38, thereby curling it under the locking strip 28. Next, the locking strip tab 34 is slid into the locking position and interconnected to the binder 10, preferably by a snap 36.

The strap 4 is secured when an end of the locking strip slot 30 selectively interconnects with a strap cutout 32. More specifically, the spine 8 is interconnected to the binder 10 with the locking strip 28 therebetween. The locking strip is thus slidingly engaged to the binder 10 and the spine 8, wherein it is capable of a first position and a second position relative to the spine 8. The first position orients the spine slot 38 and the locking strip slot 30 such that they provide an aperture to receive the end of the strap 4. The second position orients the spine slot 38 and the locking strip slot 30, such that they are overlapped to provide a smaller aperture of roughly the same dimension of the strap at the cutouts 32. Once the strap end is installed and the locking strap 28 is moved to the second position the larger end portion adjacent to the cutouts 32 is prevented from being removed.

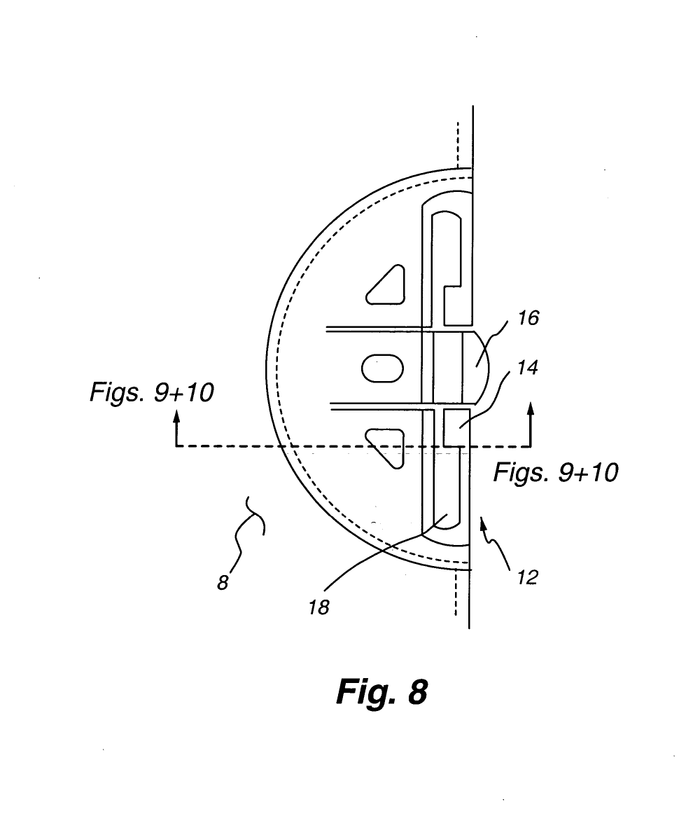

Referring specifically now to FIGS. 8-11 the latching means 12 of another embodiment of the present invention is shown herein. Preferably, the latching means 12 employs at least one hook 14 and a resiliently deflectable tab 16. In one embodiment, the latching mechanism 12 is constructed from plastic, but other materials that are capable of resilient defection may also be employed such as metallic materials, rubber, etc.

This embodiment of the present invention employs a strap with at least one aperture 5 that is used for selective interconnection to the latching mechanism 12. Alternatively, to increase a user's ability to insert and remove sheets 6, both ends of the strap 4 may be selectively interconnected to the latching mechanism. The operable interconnection of the strap 4 to the spine 8 is preferably achieved through stitching, but other interconnection means maybe employed as appreciated by one skilled in the art, such as gluing, mechanically fastening, or any other similar interconnection means.

Unlatched straps 4 receive a plurality of sheets 6 by threading the strap 4 through an aperture embodied in the sheets 6. Preferably, the sheets 6 are equipped with slot type apertures that are slightly wider than the width of the straps 4. The straps 4 are then resiliently deflected such that a latching end 17 of the strap can be inserted into a gap 18 provided when the resiliently deflectable tab is deflected. Thus, deflection of the tab 16 provides a path for which the latching end 17 of the strap 4 travels. The aperture 5 of the strap 4 is then threaded onto the hook 14 of the latching mechanism 12 and the tab 16 released. The un-deflected tab 16 and the resilient nature of the strap 4 provides sufficient forced to constrain the latching end 17 of the strap 4 so that it does not become un-hooked. The process is simply reversed to remove sheets from the binder.

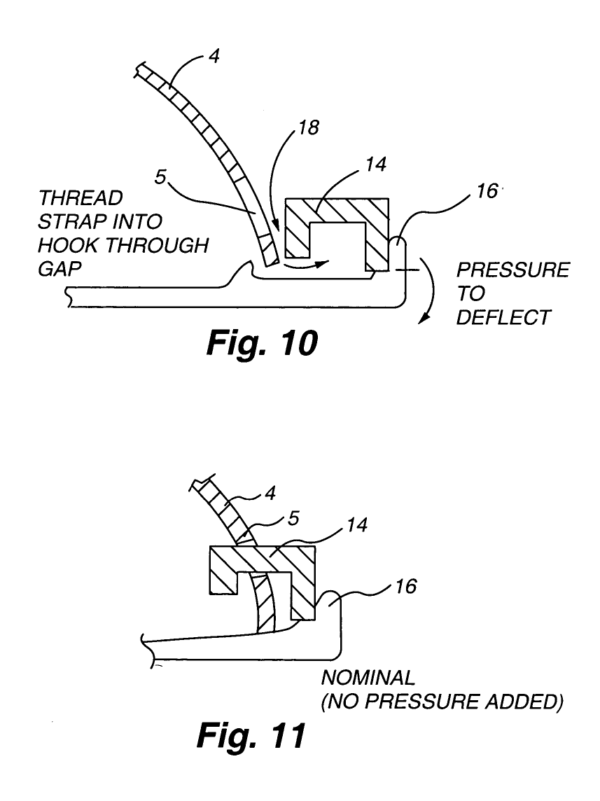

Referring now to FIGS. 10-11, views are provided herein which further aid in the description of the strap 4 latching process. As the tab 16 is resiliently deflected the gap 18 is increased. The strap aperture 5 then has sufficient clearance in order to be selectively interconnected to the hook 14. Upon release of the tab 16 un-hooking is prevented by the upward force generated by the resilient nature of the strap 4 and from tab 14 contact on the strap 4.

For clarity purposes, the following list of components and numbering associated with the present invention and drawings are provided herein as follows:

#. Component

2 Binding Device

4 Strap

5 Strap apertures

6 Sheet

8 Spine

10 Binder

12 Latching mechanism

14 Hook

16 Tab

17 Strap latching end

18 Gap

26 Latch Tab

28 Locking strip

30 Locking strip slot

32 Strap cutout

34 Locking strip tab

36 Locking strip interconnection mechanism

38 Spine slot

40 Strap end

The foregoing description of the present invention has been presented for purposes of illustration and description and is not intended to limit the invention of the form disclosed herein. Consequently, variations and modifications commensurate with the above teaching and skill and knowledge of the relevant art are within the scope of the present invention. The embodiments described herein above are further intended to explain best modes of practicing the invention and to enable others skilled in the art to utilize the invention and such or other embodiments with various modifications required by the particular application or use of the present invention. It is intended that the appended claims be construed to include alternative embodiments to the extent permitted by the prior art.

What is claimed is:

1. A binding mechanism adapted for securing sheet materials in a notebook comprising:
a spine comprising a left edge, a right edge, an inner surface and an outer surface, said spine adapted for interconnection to an interior portion of the notebook;
a strap comprising a first end and a second end, said second end having at least one aperture and said first end operably interconnected to at least one of said left edge and said right edge of said spine; and
a strap latching mechanism operatively interconnected to said spine, and comprising at least one hook and a resiliently deflectable tab, wherein deflection of said tab provides sufficient clearance for said aperture to be selectively interconnected and released from said hook, wherein the sheet materials may be inserted and removed from the notebook.

2. The binding mechanism of claim 1, wherein the sheet materials are adapted to hold at least one compact disc.

3. The binding mechanism of claim 1, wherein said spine and at least one strap are comprised of a flexible plastic material.

4. The binding mechanism of claim 1, wherein said at least one aperture of said strap is rectangular in shape.

5. The binding mechanism of claim 1, wherein said latching mechanism and said resiliently deflectable tab are comprised of a rigid plastic material interconnected to the notebook.

6. The binding mechanism of claim 1, wherein said resiliently deflectable tab may be deflected with finger pressure.

7. The binding mechanism of claim 1, wherein said resiliently deflectable tab has a rectangular shape.

8. The binding mechanism of claim 1, wherein there are at least two substantially identical straps extending at right angles from said spine.

9. A binding mechanism adapted for holding sheet materials in a notebook, comprising:
a spine comprising a left edge, a right edge, an inner surface, and an outer surface with at least one aperture extending therethrough;
at least one strap interconnected to at least one of said left edge and said right edge of said spine and having a first end and a second end, said second end having at least one recess positioned proximate thereto which has reduced width with respect to said second end of said at least one strap;
a latching mechanism comprising a left edge, a right edge, an inner surface, and an outer surface, with at least one aperture extending therethrough, said spine adapted for interconnection to the notebook with said latching mechanism positioned below said spine, wherein said left edge of said spine and said left edge of said latching mechanism are substantially parallel, and said outer surface of said spine and said inner surface of said latching mechanism are slidingly engaged; and
wherein said latching mechanism has a first unlocked position and a second locked position relative to said spine, wherein said aperture of said spine and said aperture of said latching mechanism are substantially overlapped in said first unlocked position to receive said second end of said at least one strap, and wherein said aperture of said spine and said aperture of said latching mechanism are offset in said second locked position wherein said second end of said at least one strap is substantially secured to said spine.

10. The binding mechanism of claim 9, wherein said latching mechanism further includes an upper edge with a pull tab that facilitates movement of said latching mechanism from said first unlocked position to said second locked position.

11. The binding mechanism of claim 9, wherein said latching mechanism further comprises a connecting means positioned proximate to an upper edge which is adapted to selectively interconnect with a second connecting means on the notebook to secure said latching means in said second locked position.

12. The binding mechanism of claim 9, wherein the sheet materials are adapted to hold at least one compact disc.

13. The binding mechanism of claim 9, wherein said spine, said at least one strap, and said latching mechanism are comprised of a flexible plastic material.

14. The binding mechanism of claim 9, wherein there are at least two substantially identical straps extending at right angles from a longitudinal axis of said spine.

15. A binding apparatus adapted for selectively securing sheet materials in a notebook comprising:
a substantially planar spine adapted for interconnection to said notebook, said substantially planar spine having an upper end, a lower end and lateral edges extending therebetween;
at least one aperture positioned within said substantially planar spine having a first dimension;
at least one strap having a first end interconnected to said spine and a second end having at least one recess, said second end operatively sized to travel through said aperture in said spine;
a latching mechanism positioned between said substantially planar spine and said notebook, said latching mechanism comprising a locking means for receiving said second end of said strap, wherein in a first unlocked position said second end of said strap may reciprocate within said locking means and in a second locked position said second end of said strap is secured to said locking means to prevent travel.

16. The apparatus of claim 15, wherein said locking means comprises an aperture adapted to receive said second end of said strap and which is in substantially alignment with said aperture in said spine when said locking means is in said unlocked position.

17. The apparatus of claim 15, further comprising a retention means operably interconnected to said latching mechanism for selectively securing said latching mechanism in either said locked position or said unlocked position.

18. The apparatus of claim 17, wherein said retention means comprises at least one of a snap, a velcro material and a button.

19. The apparatus of claim 15, wherein said second end of said strap has a geometric shape similar to an hourglass.

20. The apparatus of claim 16, wherein said substantially planar spine, said at least one strap and said locking mechanism are comprised of a plastic material.
